(19) United States
(12) Patent Application Publication
(10) Pub. No.: US 2025/0125878 A1
(43) Pub. Date: Apr. 17, 2025

(54) OPTICAL COMMUNICATIONS SYSTEM WITH SEMICONDUCTOR OPTICAL AMPLIFIER FOR LINK LOSS CORRECTION

(71) Applicant: X DEVELOPMENT LLC, Mountain View, CA (US)

(72) Inventor: Travis Lantz, Dublin, CA (US)

(21) Appl. No.: 18/808,660

(22) Filed: Aug. 19, 2024

Related U.S. Application Data
(60) Provisional application No. 63/590,056, filed on Oct. 13, 2023.

(51) Int. Cl. H04B 10/564; H04B 10/11; H04B 10/40; H04B 10/61

(52) U.S. Cl. CPC H04B 10/564; H04B 10/11; H04B 10/40; H04B 10/61

(57) ABSTRACT

Aspects of the disclosure provide a system comprising a first optical communications terminal having a sensor arranged in a receive path of the first terminal as well as an optical phased array architecture in a receive path of the first terminal. The first terminal also includes a first semiconductor optical amplifier (SOA) arranged in a transmit path of the first terminal and configured to adjust an outgoing optical communications signal according to power of a first incoming optical communications signal at the sensor. The first terminal also includes a second SOA arranged in the receive path of the first terminal and configured to adjust a second incoming optical communications signal according to the power of the first incoming optical communications signal at the sensor. In some instances, the second SOA is configured to adjust an outgoing optical communications signal according to information included in the first incoming optical communications signal.

### CROSS-REFERENCE TO RELATED APPLICATIONS

This application claims the benefit of the filing date of U.S. Provisional Patent Application No. 63/590,056 filed Oct. 13, 2023, the disclosure of which is hereby incorporated herein by reference.

### BACKGROUND

Wireless optical communication enables high-throughput and long-range communication, in part due to high gain offered by the narrow angular width of the transmitted beam. However, the narrow beam also requires that it must be accurately and actively pointed in order to remain aligned to an aperture of a communications terminal at the remote end. This pointing may be accomplished by small mirrors (e.g., MEMS or voice-coil based fast-steering mirror mechanisms) that are actuated to steer the beam. In other implementations, electro-optic steering of beams with no moving parts is used to steer the beam, which provides cost, lifetime and performance advantages. Optical Phased Arrays (OPAs) are a critical technology component, with added benefits of adaptive-optics, point-to-multipoint support, and mesh network topologies. Each active element in the OPA requires electro-optic phase shifting capability.

### BRIEF SUMMARY

Aspects of the disclosure provide a system including a first optical communications terminal. The first optical communications terminal includes a sensor arranged in a receive path of the first optical communications terminal; an optical phased array architecture in a receive path of the first optical communications terminal; a first semiconductor optical amplifier (SOA) arranged in a transmit path of the first optical communications terminal and configured to adjust an outgoing optical communications signal according to power of a first incoming optical communications signal at the sensor; and a second SOA arranged in the receive path of the first optical communications terminal and configured to adjust a second incoming optical communications signal according to the power of the first incoming optical communications signal at the sensor.

In one example, the second SOA is further configured to adjust the second incoming optical communications signal according to power of the first incoming optical communications signal at the optical phased array architecture. In another example, the system also includes a state machine configured to control the second SOA based on power of the first incoming optical communications signal at the sensor. In this example, the state machine is further configured to control the second SOA based on the power of the first incoming optical communications signal at the optical phased array architecture. In another example, the system includes a state machine configured to control the first SOA based on the power of the first incoming optical communications signal at the sensor. In another example, the system also includes a second optical communications terminal, wherein the second optical communications terminal is configured to transmit the first incoming optical communications signal and the second incoming optical communications signal.

Another aspect of the disclosure provides a system including a first optical communications terminal. The first optical communications terminal includes a sensor arranged in a receive path of the first optical communications terminal; an optical phased array architecture in a receive path of the first optical communications terminal; a first semiconductor optical amplifier (SOA) arranged in a transmit path of the first optical communications terminal and configured to adjust an outgoing optical communications signal according to information included in a first incoming optical communications signal; and a second SOA arranged in the receive path of the first optical communications terminal and configured to adjust a second incoming optical communications signal according to the power of the first incoming optical communications signal at the sensor.

In one example, the second SOA is further configured to adjust the second incoming optical communication signal according to power of the first incoming optical communications signal at the optical phased array architecture. In another example, the system also includes a state machine configured to control the second SOA based on the power of the first incoming optical communications signal at the sensor. In this example, the state machine is further configured to control the second SOA based on the power of the first incoming optical communications signal at the optical phased array architecture. In another example, the system also includes a state machine configured to control the first SOA based on the information. In another example, the information identifies power of a second outgoing optical communications signal received at a sensor of a second optical communications terminal, and the second outgoing optical communications signal was transmitted by the first optical communications terminal to the second optical communications terminal. In another example, the system also includes a second optical communications terminal, and the second optical communications terminal is configured to transmit the first incoming optical communications signal and the second incoming optical communications signal.

Another aspect of the disclosure provides a method. The method includes receiving a first incoming optical communications signal at a sensor via a receive path of a first optical communications terminal; adjusting an outgoing optical communications signal using a first semiconductor optical amplifier (SOA) arranged in a transmit path of the first optical communications terminal, wherein the adjusting is according to power of the first incoming optical communications signal at the sensor; and adjusting a second incoming optical communications signal using a second SOA arranged in the receive path of the first optical communications terminal, wherein the adjusting is according to power of the first incoming optical communications signal at the sensor.

In one example, the method also includes adjusting the second incoming optical communications signal further according to the power of the first incoming optical communications signal at an optical phased array architecture of the first optical communications terminal.

Another aspect of the disclosure provides a method. The method includes receiving a first incoming optical communications signal at a sensor via a receive path of a first optical communications terminal; adjusting an outgoing optical communications signal using a first semi-conductor optical amplifier (SOA) arranged in a transmit path of the first optical communications terminal, wherein the adjusting is according to information included in the first incoming optical communications signal; and adjusting a second incoming optical communications signal using a second SOA arranged in the receive path of the first optical communications terminal, wherein the adjusting is according to power of the first incoming optical communications signal at the sensor.

In one example, the method also includes adjusting the second incoming optical communications signal further according to the power of the first incoming optical communications signal at an optical phased array architecture of the first optical communications terminal. In another example, the information identifies power of a second outgoing optical communications signal received at a sensor of a second optical communications terminal, and the method further comprises transmitting the second outgoing optical communications signal by the first optical communications terminal to the second optical communications terminal.

### BRIEF DESCRIPTION OF THE DRAWINGS

FIG. 1 is a block diagram 100 of a first optical communications terminal and a second optical communications terminal in accordance with aspects of the disclosure.

FIG. 2 is a pictorial diagram 200 of an example system architecture for the first optical communications terminal of FIG. 1 in accordance with aspects of the disclosure.

FIG. 3 represents features of an OPA architecture represented as an example OPA chip in accordance with aspects of the disclosure.

FIG. 4 is a pictorial diagram of a network in accordance with aspects of the disclosure.

FIGS. 5A and 5B are an example representation of a cross-coupling effect in accordance with aspects of the disclosure.

FIG. 6 is an example representation of reducing of a cross-coupling effect in accordance with aspects of the disclosure.

FIG. 7 is an example representation of reducing of a cross-coupling effect in accordance with aspects of the disclosure.

FIG. 8 is an example representation of reducing a cross-coupling effect in accordance with aspects of the disclosure.

FIG. 9 is an example representation of reducing a cross-coupling effect in accordance with aspects of the disclosure.

FIG. 10 is a flow diagram in accordance with aspects of the disclosure.

FIG. 11 is a flow diagram in accordance with aspects of the disclosure.

### DETAILED DESCRIPTION

### Overview

The technology relates to free space optical communications (FSOC) systems and control of link loss correction via a photonic integrated circuit (PIC) with a semiconductor optical amplifier. Link loss may be caused by numerous factors, including, for instance, atmospheric conditions such as wind, precipitation, debris, pressure etc. In addition, due to the dynamic nature of the atmosphere, there may be relatively large variations in received power of a FSOC terminal, spanning over 40 dB, or a 10,000 to 1 change in received power over a few hundred microseconds. Such large fluctuations in power may exceed normal saturation or sensitivity of a sensor of the receiver. Typical approaches for control of link loss correction may include the use of various types of amplifiers. However, conventional fiber amplifiers may have limitations in both size and cost, making them prohibitive for a high level of integration in a small form factor optical wireless communications terminal.

To address these issues in a bi-directional FSOC communications terminal and thereby reduce a cross-coupling effect, a first SOA (semiconductor optical amplifier) may be used on the “transmit” path, and a second SOA (e.g., a SOA pre-amplifier) may be used on the “receive” path. However, rather than running a high power amplifier and a lower gain preamplifier at maximum power all of the time, control of these components may be done adaptively as described further below. Adaptive and active power control may be utilized to maintain sufficient margin on the receive path to successfully pass data traffic over turbulent atmospheric channels as well as to prevent saturation and possibly damage.

As noted above, a bi-directional FSOC communications terminal may include a first SOA in a transit path of outgoing optical communications signals (e.g., in the form of light) or in order to transmit the outgoing optical communications signals as well as a second SOA in a receive path of incoming optical communications signals (e.g., in the form of light) to boost the power of the incoming optical communications signal. The first SOA may be a high-power SOA, and the second SOA may be a lower gain SOA pre-amplifier. However, as noted above, rather than operating the first and second SOAs at a constant fixed gain and power, these can be dynamically controlled to provide gain or attenuation.

Control of the first SOA of a first optical communications terminal (or a second optical communications terminal) may be adjusted adaptively based on disturbance criteria (e.g., Feedback from the pointing and tracking system, input from an IMU, or adaptive modeling of upcoming atmospheric disturbances) as well as in power of incoming optical communications signals received by the first optical communications terminal and/or the second optical communications terminal.

In some instances, the power of signals received at the receiver or sensor of the second optical communications terminal may also be used to adaptively adjust the gain rate of the first SOA of the first optical communications terminal. This may be used to prevent fades in power and also to decrease power in order to prevent saturation of a sensor at the second optical communications terminal. Such information may be provided to the first optical communications terminal from the second optical communications terminal via a communication link. In some instances, feedback from a tracking system of the first optical communications terminal may be used to identify atmospheric disturbances outside of the bounds of operation in order to ensure stability.

Control of the second SOA of the first optical communications terminal (or second optical communications terminal) may be achieved using a feedback mechanism. This mechanism may include an actual power measurement at the sensor. This may be achieved via feedback from the photodetector, via a bias monitor or a current mirror with a high sensitivity log-limiting amplifier. As with the first SOA, a finite state machine may be utilized to set update rate and control loop speed for the second SOA, based on identification of weather patterns for the aforementioned power measurements.

Alternatively, control of the second SOA of the first optical communications terminal (or second optical communications terminal) may be achieved using a dual feedback mechanism. This mechanism may include a total-power measurement at the OPA architecture as well as an “actual power” measurement at the sensor. This may be achieved via feedback from the photodetector, via a bias monitor or a current mirror with a high sensitivity log-limiting amplifier. As with the first SOA, a finite state machine may be utilized to set update rate and control loop speed for the second SOA, based on identification of weather patterns for the aforementioned power measurements. This dual feedback mechanism may allow for both a preemptive power adjustment, as well as to provide for feedback and prevention of an unstable response by the second SOA.

The total power measurement may be made at the OPA architecture, and the actual power measurement may be made at the sensor. This may be used to provide a feedback trim (e.g., correction) of the driven gain of the second SOA by an additional increase or decrease in the gain in order to maintain the receiver power within a stable band of performance for the first communication device. The total power measurement may be similar in nature to the actual power measurement, but the use of the actual power measurement may provide a secondary corrective process to the gain of the second SOA that could not be achieved by using adaptive control based on the total power measurement alone.

The features described herein may provide for an optical communications terminal with co-integration and packaging of an optical transceiver as well as the first and second SOAs. Control of the first and second SOAs at different optical communications terminals may be done adaptively without direct feedback or knowledge of the state of the other SOA even while controlling the overall power level of the same communications signal (outgoing at one optical communications terminal and incoming at another optical communications terminal). Thus, the features described herein may also account for the dual independent control of the same optical path (e.g., transmit path of a first optical communications terminal to receive path of a second optical communications terminal).

### Example Systems

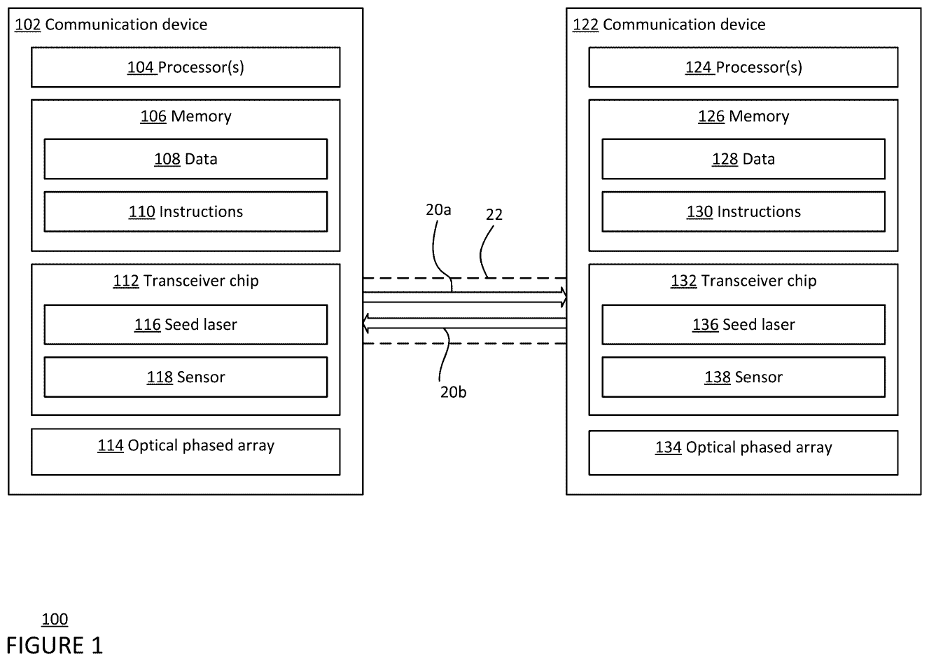

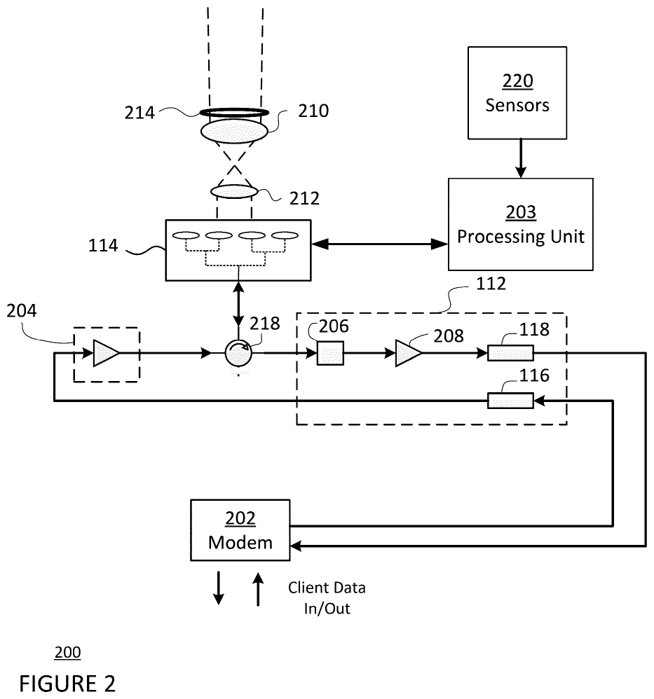

FIG. 1 is a block diagram 100 of a first optical communications terminal configured to form one or more links with a second optical communications terminal, for instance as part of a system such as a free-space optical communication (FSOC) system. FIG. 2 is a pictorial diagram 200 of an example communications terminal, such as the first optical communications terminal of FIG. 1. For example, a first optical communications terminal 102 includes one or more processors 104, a memory 106, a transceiver photonic integrated chip 112, and an optical phased array (OPA) architecture 114. In some implementations, the first optical communications terminal 102 may include more than one transceiver chip and/or more than one OPA architecture (e.g., more than one OPA chip).

The one or more processors 104 may be any conventional processors, such as commercially available CPUs. Alternatively, the one or more processors may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, such as in a modem 202 for digital signal processing shown in FIG. 2, the one or more processors 104 and memory 106 may actually comprise multiple processors and memories that may or may not be stored within the same physical housing, such as in both the modem 202 and a separate processing unit 203. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms “instructions” and “programs” may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the transceiver chip 112. As shown in FIG. 2, the one or more processors in the modem 202 may be in communication with the transceiver chip 112, being configured to receive and process incoming optical signals and to transmit optical signals. The transceiver chip 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include at minimum a light source, such as seed laser 116. Other transmitter components may include an amplifier, such as a high-power semiconductor optical amplifier 204. In some implementations, the amplifier is on a separate photonics chip. The seed laser 116 may be a distributed feedback laser (DFB), a laser diode, a fiber laser, or a solid-state laser. The light output of the seed laser 116, or optical signal, may be controlled by a current, or electrical signal, applied directly to the seed laser, such as from a modulator that modulates a received electrical signal. Light transmitted from the seed laser 116 is received by the OPA architecture 114.

The receiver components may include at minimum a sensor 118, such as a photodiode. The sensor may convert a received signal (e.g., light or optical communications beam), into an electrical signal that can be processed by the one or more processors. Other receiver components may include an attenuator, such as a variable optical attenuator 206, an amplifier, such as a semiconductor optical amplifier 208, or a filter.

The one or more processors 104 may be in communication with the OPA architecture 114. The OPA architecture may include a micro-lens array, an emitter associated with each micro-lens in the array, a plurality of phase shifters, and waveguides that connect the components in the OPA. The OPA architecture may be positioned on a single chip or photonic integrated chip or (PIC). The waveguides progressively merge between a plurality of emitters and an edge coupler that connect to other transmitter and/or receiver components. In this regard, the waveguides may direct light between photodetectors or fiber outside of the OPA architecture, the phase shifters the waveguide combiners, the emitters and any additional component within the OPA. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2×2 multimode interference (MMI) or directional coupler.

The OPA architecture 114 may receive light from the transmitter components and outputs the light as a coherent communications beam to be received by a remote communications terminal, such as second optical communications terminal 122. The OPA architecture 114 may also receive light from free space, such as a communications beam from second optical communications terminal 122, and provides such received light to the receiver components. The OPA architecture may provide the necessary photonic processing to combine an incoming optical communications beam into a single-mode waveguide that directs the beam towards the transceiver chip 112. In some implementations, the OPA architecture may also generate and provide an angle of arrival estimate to the one or more processors 104, such as those in processing unit 203.

The first optical communications terminal 102 may include additional components to support functions of the optical communications terminal. For example, the first optical communications terminal may include one or more lenses and/or mirrors that form a telescope. The telescope may receive collimated light and output collimated light. The telescope may include an objective portion, an eyepiece portion, and a relay portion. As shown in FIG. 2, the first optical communications terminal may include a telescope including an objective lens 210, an eyepiece lens 212, and an aperture 214 (or opening) through which light may enter and exit the optical communications terminal. For ease of representation and understanding, the aperture 214 is depicted as distinct from the objective lens 210, though the objective lens 210 may be positioned within the aperture. The first optical communications terminal may include a circulator or wavelength splitter, such as a single mode circulator 218, that routes incoming light and outgoing light while keeping them on at least partially separate paths. The first optical communications terminal may include one or more sensors 220 for detecting measurements of environmental features and/or system components.

The first optical communications terminal 102 may include one or more steering mechanisms, such as one or more bias means for controlling one or more phase shifters, which may be part of the OPA architecture 114, and/or an actuated/steering mirror (not shown), such as a fast/fine pointing mirror. In some examples, the actuated mirror may be a MEMS 2-axis mirror, 2-axis voice coil mirror, or a piezoelectric 2-axis mirror. The one or more processors 104, such as those in the processing unit 203, may be configured to receive and process signals from the one or more sensors 220, the transceiver chip 112, and/or the OPA architecture 114 and to control the one or more steering mechanisms to adjust a pointing direction and/or wavefront shape. The first optical communications terminal also includes optical fibers, or waveguides, connecting optical components, creating a path between the seed laser 116 and OPA architecture 114 and a path between the OPA architecture 114 and the sensor 118.

Returning to FIG. 1, the second optical communications terminal 122 may output the Tx signals as an optical communications beam 20b (e.g., light) pointed towards the first optical communications terminal 102, which receives the optical communications beam 20b (e.g., light) as corresponding Rx signals. In this regard, the second optical communications terminal 122 includes one or more processors, 124, a memory 126, a transceiver chip 132, and an OPA architecture 134. The one or more processors 124 may be similar to the one or more processors 104 described above.

Memory 126 may store information accessible by the one or more processors 124, including data 128 and instructions 130 that may be executed by processor 124. Memory 126, data 128, and instructions 130 may be configured similarly to memory 106, data 108, and instructions 110 described above. In addition, the transceiver chip 132 and the OPA architecture 134 of the second optical communications terminal 122 may be similar to the transceiver chip 112 and the OPA architecture 114. The transceiver chip 132 may include both transmitter components and receiver components. The transmitter components may include a light source, such as seed laser 136 configured similar to the seed laser 116. Other transmitter components may include an amplifier, such as a high-power semiconductor optical amplifier. The receiver components may include a sensor 138 configured similar to sensor 118. Other receiver components may include an attenuator, such as a variable optical attenuator, an amplifier, such as a semiconductor optical amplifier, or a filter. The OPA architecture 134 may include an OPA chip including a micro-lens array, a plurality of emitters, a plurality of phase shifters. Additional components for supporting functions of the second optical communications terminal 122 may be included similar to the additional components described above. The second optical communications terminal 122 may have a system architecture that is same or similar to the system architecture shown in FIG. 2.

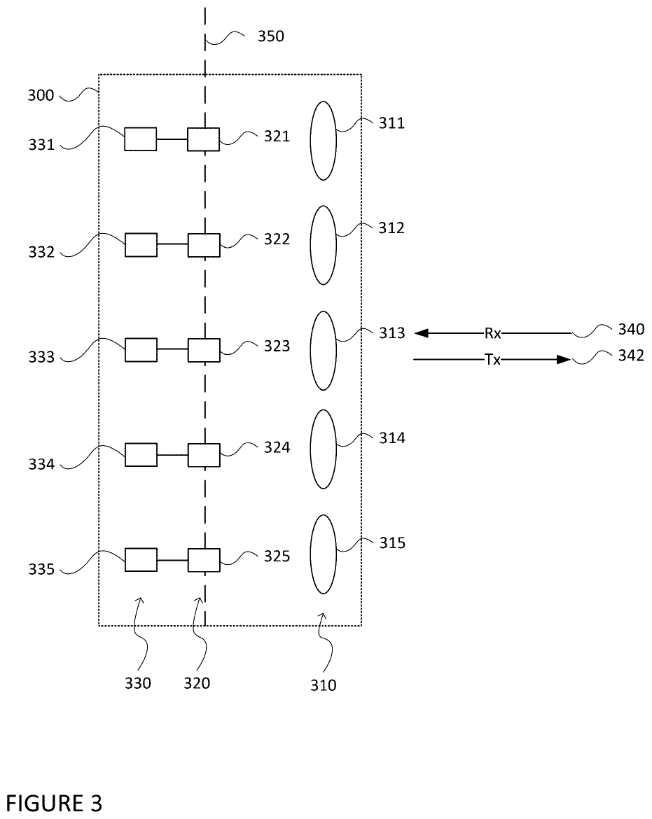

FIG. 3 represent features of OPA architecture 114 represented as an example OPA chip 300 including representations of a micro-lens array 310, a plurality of emitters 320, and a plurality of phase shifters 330. For clarity and ease of understanding, additional waveguides and other features are not depicted. Arrows 340, 342 represent the general direction of Tx signals (transmitted optical communications beam) and Rx signals (received optical communications beam) as such signals pass or travel through the OPA chip 300.

The micro-lens array 310 may include a plurality of convex micro-lenses 311-315 that focus the Rx signals onto respective ones of the plurality emitters positioned at the focal points of the micro-lens array. In this regard, the dashed-line 350 represents the focal plane of the micro-lenses 311-315 of the micro-lens array 310. The micro-lens array 310 may be arranged in a grid pattern with a consistent pitch, or distance, between adjacent lenses. In other examples, the micro-lens array 310 may be in different arrangements having different numbers of rows and columns, different shapes, and/or different pitch (consistent or inconsistent) for different lenses.

Each micro-lens of the micro-lens array may be 10's to 100's of micrometers in diameter and height. In addition, each micro-lens of the micro-lens array may be manufactured by molding, printing, or etching a lens directly into a wafer of the OPA chip 300. Alternatively, the micro-lens array 310 may be molded as a separately fabricated micro-lens array. In this example, the micro-lens array 310 may be a rectangular or square plate of glass or silica a few mm (e.g., 10 mm or more or less) in length and width and 0.2 mm or more or less thick. Integrating the micro-lens array within the OPA chip 300 may allow for the reduction of the grating emitter size and an increase in the space between emitters. In this way, two-dimensional waveguide routing in the OPA architecture may better fit in a single layer optical phased array. In other instances, rather than a physical micro-lens array, the function of the micro-lens array may be replicated using an array of diffractive optical elements (DOE).

Each micro-lens of the micro-lens array may be associated with a respective emitter of the plurality of emitters 320. For example, each micro-lens may have an emitter from which Tx signals are received and to which the Rx signals are focused. As an example, micro-lens 311 is associated with emitter 321. Similarly, each micro-lens 312-315 also has a respective emitter 322-325. In this regard, for a given pitch (i.e., edge length of a micro-lens edge length) the micro-lens focal length may be optimized for best transmit and receive coupling to the underlying emitters. This arrangement may thus increase the effective fill factor of the Rx signals at the respective emitter, while also expanding the Tx signals received at the micro-lenses from the respective emitter before the Tx signals leave the OPA chip 300.

The plurality of emitters 320 may be configured to convert emissions from waveguides to free space and vice versa. The emitters may also generate a specific phase and intensity profile to further increase the effective fill factor of the Rx signals and improve the wavefront of the Tx signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The phase shifters 330 may allow for sensing and measuring Rx signals and the altering of Tx signals to improve signal strength optimally combining an input wavefront into a single waveguide or fiber. Each emitter may be associated with a phase shifter. As shown in FIG. 3, each emitter may be connected to a respective phase shifter. As an example, the emitter 320 is associated with a phase shifter 330. The Rx signals received at the phase shifters 331-335 may be provided to receiver components including the sensor 118, and the Tx signals from the phase shifters 331-335 may be provided to the respective emitters of the plurality of emitters 320. The architecture for the plurality of phase shifters 330 may include at least one layer of phase shifters having at least one phase shifter connected to an emitter of the plurality of emitters 320. In some examples, the phase shifter architecture may include a plurality of layers of phase shifters, where phase shifters in a first layer may be connected in series with one or more phase shifters in a second layer.

A communication link 22 may be formed between the first optical communications terminal 102 and the second optical communications terminal 122 when the transceivers of the first and second optical communications terminals are aligned. The alignment can be determined using the optical communications beams 20a, 20b to determine when line-of-sight is established between the optical communications terminals 102, 122. Using the communication link 22, the one or more processors 104 can send communication signals using the optical communications beam 20a to the second optical communications terminal 122 through free space, and the one or more processors 124 can send communication signals using the optical communications beam 20b to the first optical communications terminal 102 through free space. The communication link 22 between the first and second optical communications terminals 102, 122 allows for the bi-directional transmission of data between the two devices. In particular, the communication link 22 in these examples may be free-space optical communications (FSOC) links. In other implementations, one or more of the communication links 22 may be radio-frequency communication links or other type of communication link capable of traveling through free space.

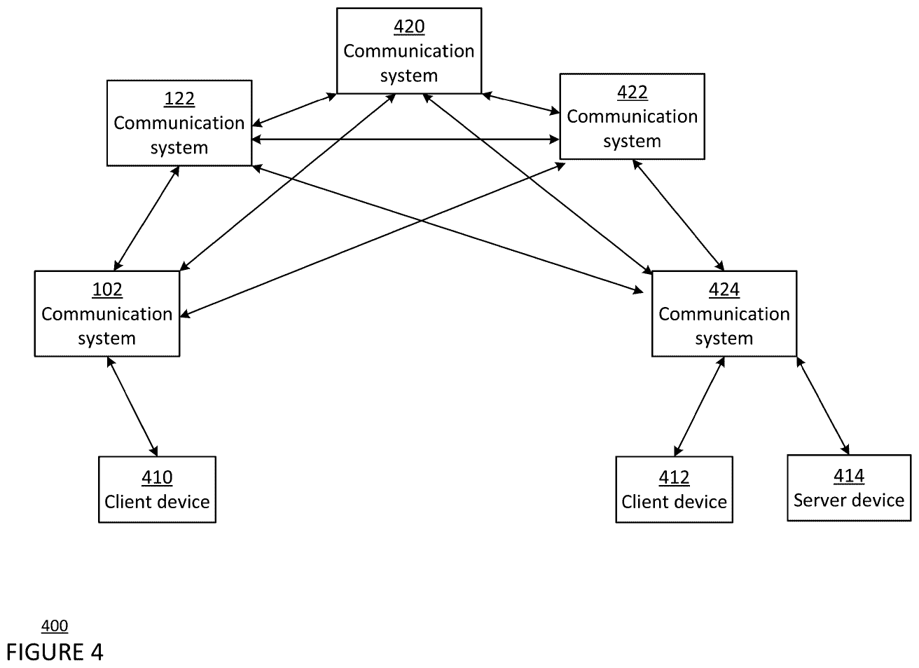

As shown in FIG. 4, a plurality of communications terminals, such as the first optical communications terminal 102 and the second optical communications terminal 122, may be configured to form a plurality of communication links (illustrated as arrows) between a plurality of communications terminals, thereby forming a network 400. The network 400 may include client devices 410 and 412, server device 414, and communications terminals 102, 122, 420, 422, and 424. Each of the client devices 410, 412, server device 414, and communications terminals 420, 422, and 424 may include one or more processors, a memory, a transceiver chip, and an OPA architecture (e.g., OPA chip or chips) similar to those described above. Using the transmitter and the receiver, each communications terminal in network 400 may form at least one communication link with another communications terminal, as shown by the arrows. The communication links may be for optical frequencies, radio frequencies, other frequencies, or a combination of different frequency bands. In FIG. 4, the first optical communications terminal 102 is shown having communication links with client device 410 and communications terminals 122, 420, and 422. The second optical communications terminal 122 is shown having communication links with communications terminals 102, 420, 422, and 424.

The network 400 as shown in FIG. 4 is illustrative only, and in some implementations the network 400 may include additional or different communications terminals. The network 400 may be a terrestrial network where the plurality of communications terminals is on a plurality of ground communications terminals. In other implementations, the network 400 may include one or more high-altitude platforms (HAPs), which may be balloons, blimps or other dirigibles, airplanes, unmanned aerial vehicles (UAVs), satellites, or any other form of high-altitude platform, or other types of moveable or stationary communications terminals. In some implementations, the network 400 may serve as an access network for client devices such as cellular phones, laptop computers, desktop computers, wearable devices, or tablet computers. The network 400 also may be connected to a larger network, such as the Internet, and may be configured to provide a client device with access to resources stored on or provided through the larger computer network.

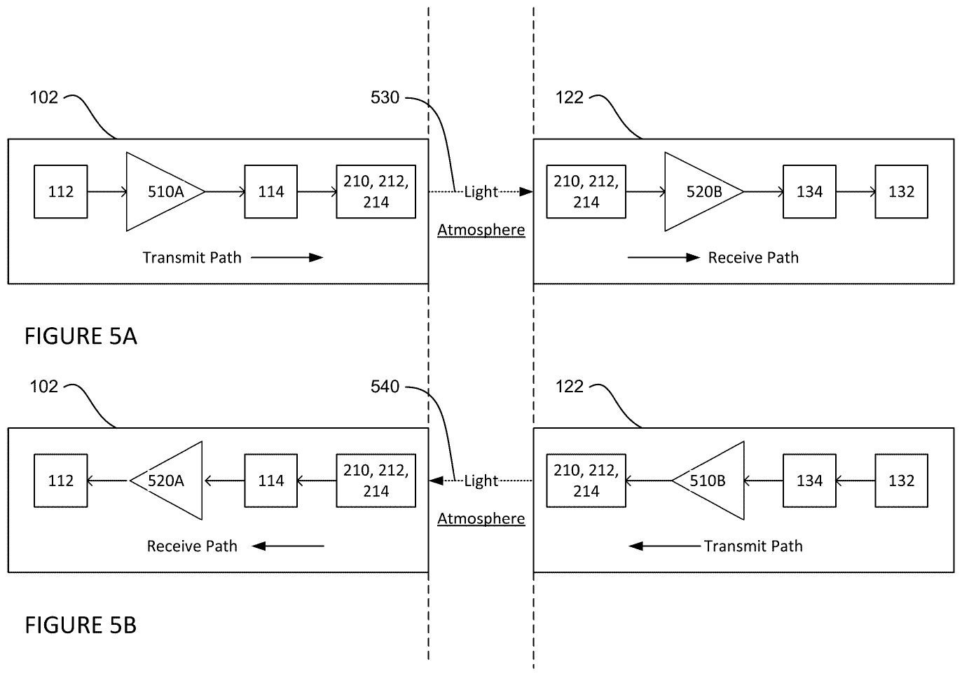

As noted above, each of the first and second optical communications terminal may include, a first SOA (semiconductor optical amplifier) may be used on the “transmit” path, and a second SOA (e.g., a SOA pre-amplifier) may be used on the “receive” path. For instance, as shown in FIG. 5A, the first optical communications terminal 102 may include a first SOA 510A in a transit path of outgoing optical communications signals (e.g., in the form of light) or in order to transmit the outgoing optical communications signals. The second optical communications terminal 122, may include a second SOA 520B in a receive path of incoming optical communications signals (e.g., in the form of light) to boost the power of the incoming optical communications signal. Direction of arrow 530 corresponds to the direction of light passing from the transmit path of the first optical communications terminal 102 to the receive path of the second optical communications terminal 122.

Similarly, as shown in FIG. 5B, the second optical communications terminal 122 may include a first SOA 510B in a transit path of outgoing optical communications signals (e.g., in the form of light) or in order to transmit the outgoing optical communications signals. The second optical communications terminal 122, may include a second SOA 520B in a receive path of incoming optical communications signals (e.g., in the form of light) to boost the power of the incoming optical communications signal. Direction of arrow 540 corresponds to the direction of light passing from the transmit path of the first optical communications terminal 122 to the receive path of the second optical communications terminal 102.

Although the location of the first and second SOAs are depicted relative to the transceiver chips 112, 132, OPA architecture 114, 134, and the telescope features in FIGS. 5A and 5B, this is for reference only and the first and second communications terminals 102, 122 may include additional features.

The first SOA 510A, 510B may be a high-power SOA. For example, the first SOA may be configured to handle up to 1 W-2 W or 30-33 dBm of output power or more or less. The Second SOA 520A, 520B may be a lower gain SOA pre-amplifier. For example, the second SOA 520A, 520B may be configured to provide between 15-20 dBm of power, and as such, 3-5 times lower gain than a high-power SOA. However, as noted above, rather than operating the first and second SOAs at a constant fixed gain and power, these can be dynamically controlled to provide gain or attenuation.

### Example Methods

As noted above, rather than running the first and second SOAs at maximum power all of the time, control of these components may be done adaptively. Adaptive and active power control may be utilized to maintain sufficient margin on the receive path to successfully pass data traffic over turbulent atmospheric channels as well as to prevent saturation and possibly damage.

The feedback mechanism for the first and second SOAs and pre-amp SOA may be used to stabilize performance of the optical communications terminals and limit the effects atmospheric dynamics. This, in turn, may enable the use of various different types of modulation formals, including, for example, typical on-off keying (OOK), other form of amplitude-shift keying (ASK) modulation, intensity modulation, direct detect (IMDD), differential phase shift keying (DPSK) modulation, and so on which would otherwise require additional compensation features to maintain functionality.

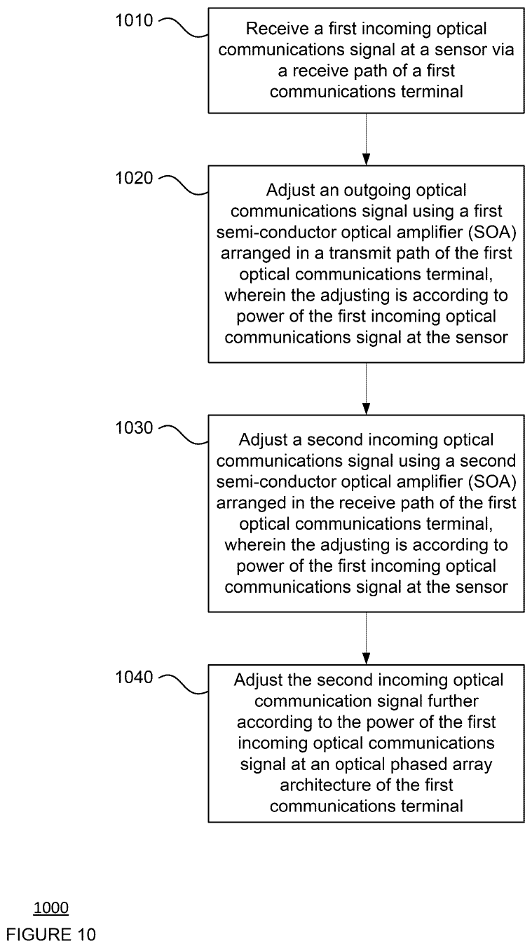

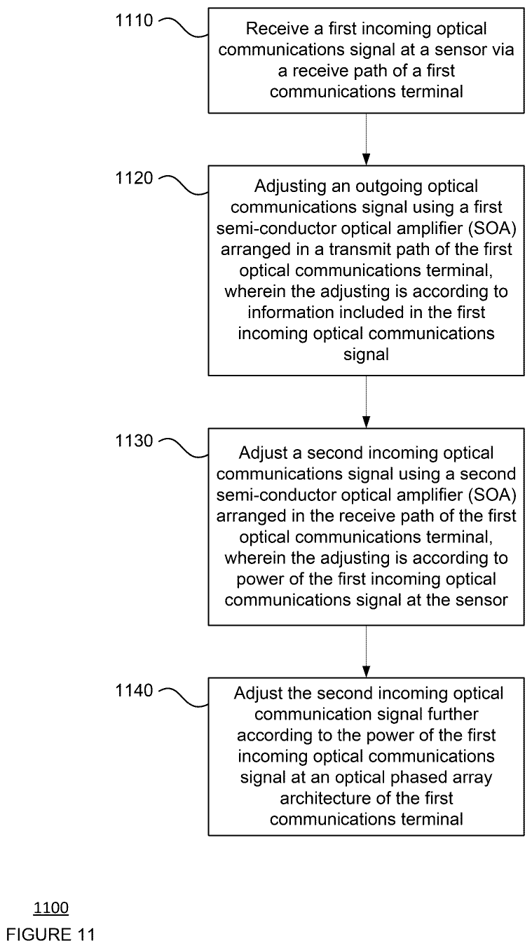

FIGS. 10 and 11, are example flow diagrams 1000, 1100, of reduce a cross-coupling effect, respectively. These flow diagrams are shown in accordance with some of the aspects described above that may be performed by the one or more processors 104 of the first optical communications terminal 102. Additionally, or alternatively, the one or more processors 124 of the second optical communications terminal 122 may perform one or more steps of the flow diagrams 1000, 1100. While FIGS. 10 and 11 show blocks in a particular order, the order may be varied and that multiple operations may be performed simultaneously. Also, operations may be added or omitted.

Turning to FIG. 10, at block 1010, a first incoming optical communications signal is received at a sensor via a receive path of a first optical communications terminal. In addition, at block 1020, an outgoing optical communications signal is adjusted using a first semi-conductor optical amplifier (SOA) arranged in a transmit path of the first optical communications terminal, wherein the adjusting is according to power of the first incoming optical communications signal at the sensor.

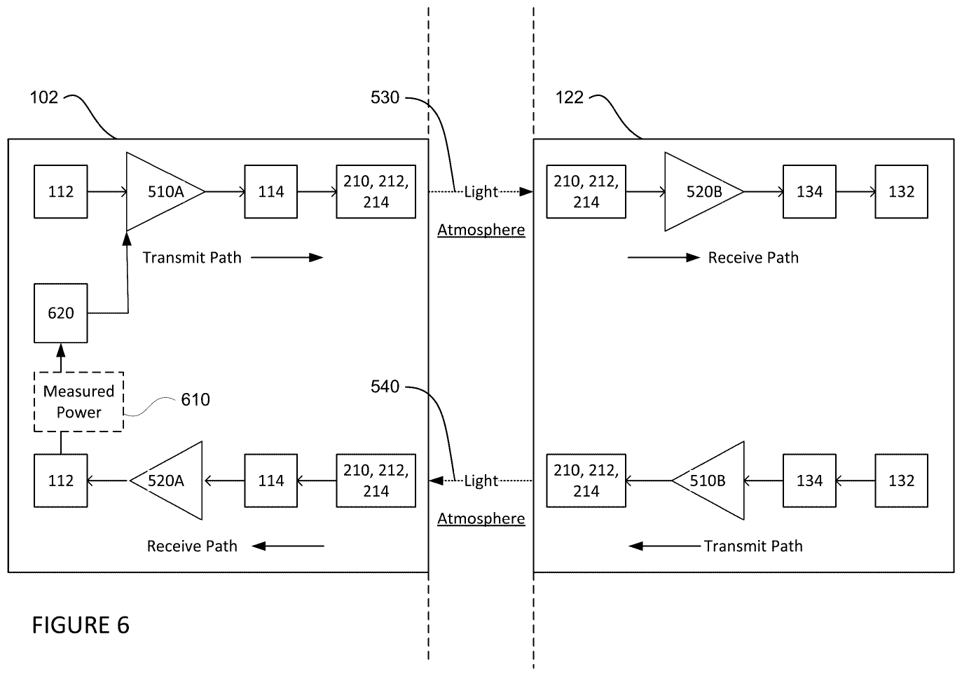

For instance, control of the first SOA 510A of the first optical communications terminal 102 (or the first SOA 510B of the second optical communications terminal 122) may be adjusted adaptively based on disturbance criteria (e.g., feedback from the pointing and tracking system, input from an IMU, or adaptive modeling of upcoming atmospheric disturbances) as well as in power of incoming optical communications signals received by the first optical communications terminal and/or the second optical communications terminal. For instance, FIG. 6 provides an example representation of reducing of a cross-coupling effect in accordance with aspects of the disclosure. FIG. 6 depicts both the transmit and receive paths together for ease of understanding, the measured power 610 of incoming optical communications signals to the first optical communications terminal 102 may be measured using the sensor 118 and may be used to drive a state machine 620 which controls an update rate of the control loop at which the gain of the first SOA 510A is adjusted. The measurements may be performed using an update period on the order of 1 Hz. For instance, the first SOA 510A may be adapted dynamically to pre-compensate an outgoing optical communications signal for slow atmospheric trends.

Turning to FIG. 11, at block 1110, a first incoming optical communications signal is received at a sensor via a receive path of a first optical communications terminal. In addition, at block 1120, an outgoing optical communications signal is adjusted using a first semiconductor optical amplifier (SOA) arranged in a transmit path of the first optical communications terminal. This adjusting is according to information included in the first incoming optical communications signal.

In some instances, the measured power of incoming optical communications signals received at the sensor of the transceiver chip 132 of the second optical communications terminal 122 may additionally (or alternatively) be used to adaptively adjust the gain rate of the first SOA 510A of the first optical communications terminal 102. This may be used to prevent fades in power and also to decrease power in order to prevent saturation of a sensor at the second optical communications terminal. Such information may be provided to the first optical communications terminal from the second optical communications terminal via the communication link.

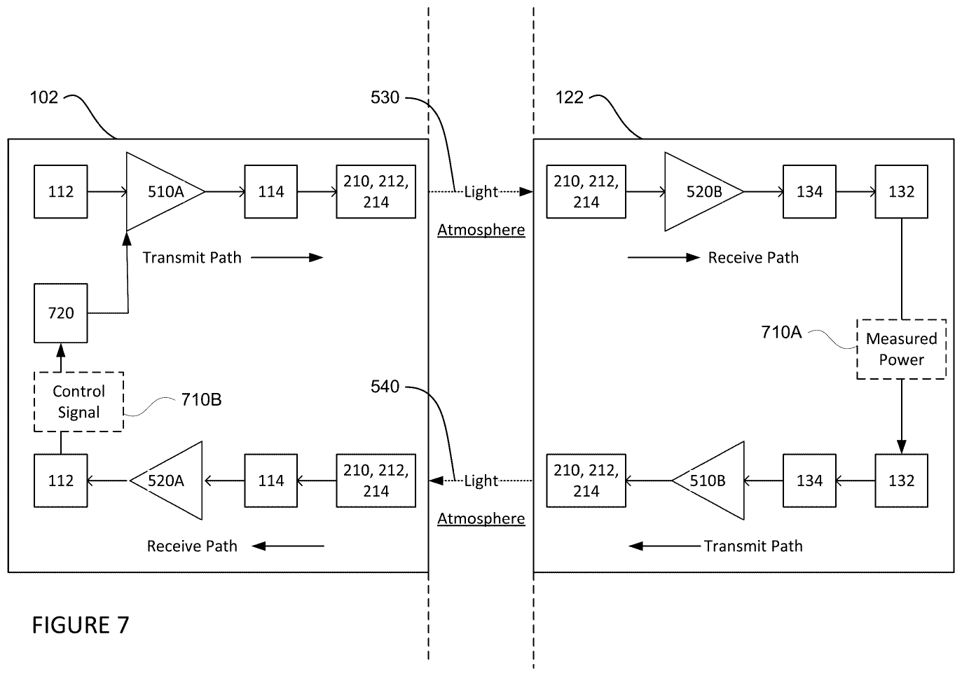

FIG. 7 provides an example representation of reducing of a cross-coupling effect in accordance with aspects of the disclosure. As shown in FIG. 7, the optical communications terminal 122 may embed formation including measured power 710A of an incoming optical communications signal at the sensor of the transceiver chip 132 as a control signal 710B into an outgoing optical communications signal transmitted to the first optical communications terminal. 102. For instance, the control signal 710B may be embedded in communication channel overhead for the communication link 22 and may be optimized to adaptively change the gain to account for slow atmospheric attenuation changes. As with the example of FIG. 6, the control signal 710B may be used to drive a state machine 720 which controls an update rate of the control loop at which the gain of the first SOA 510A is adjusted.

In some instances, feedback from the tracking system of the first optical communications terminal may be used to identify atmospheric disturbances outside of the bounds of operation in order to ensure stability. For instance, if a disturbance is detected, whether physical or atmospheric, that exceeds system performance, the adaptive control of the first SOA 510A, 510B can be bounded or updated to protect the system. Alternatively, the adaptive control may be boosted proactively in order to at least partially compensate for additional losses in power due to pointing error caused by atmospheric disturbances.

Returning to FIGS. 10 and 11, as shown in blocks 1030 and 1130, respectively, a second incoming optical communications signal is adjusted using a second semiconductor optical amplifier (SOA) arranged in the receive path of the first optical communications terminal. This adjusting may be performed according to the power of the first incoming optical communications signal as received at the sensor.

For instance, control of the second SOA 520A of the first optical communications terminal 102 (or the second SOA 520B of the second optical communications terminal 122) may be achieved using a feedback mechanism. This feedback mechanism may include an actual power measurement 810 at the sensor 118. This may be achieved via feedback from the photodetector, via a bias monitor or a current mirror with a high sensitivity log-limiting amplifier. As with the first SOA, a finite state machine 820 may be utilized to set update rate and control loop speed for the second SOA 520A, based on identification of weather patterns for the actual power measurement 810. The control rate may vary from a few Hz's (e.g., 1-2 Hz) to hundreds of Hz's, based on identified atmospheric conditions, and may be adaptively tuned to prevent instability in the feedforward/feedback control of the second SOA.

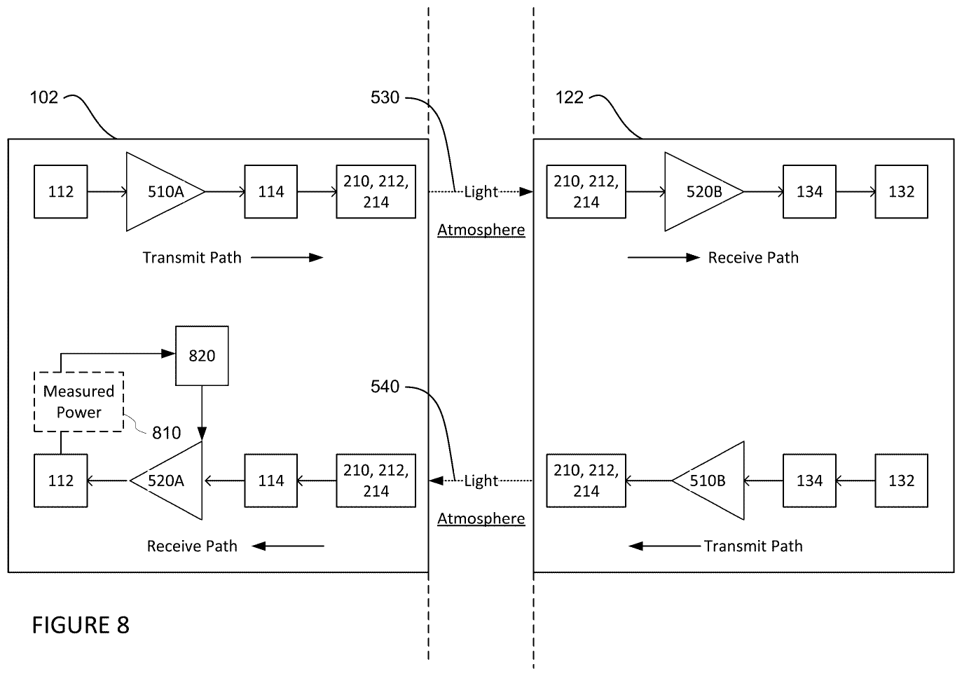

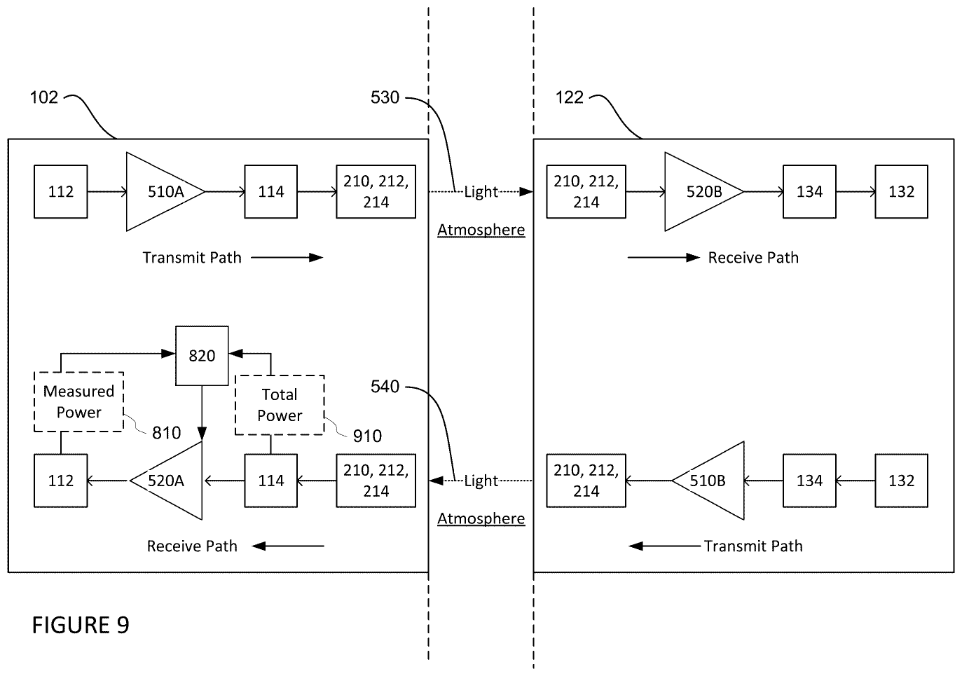

In some instances, control of the second SOA 520A of the first optical communications terminal 102 (or of the second SOA 520B of the second optical communications terminal 122) may be achieved using a dual feedback mechanism as depicted in the example representation of reducing a cross-coupling effect of FIG. 9. This mechanism may include an “actual power” measurement at the sensor as in the example of reducing a cross-coupling effect as depicted in FIG. 8 (and blocks 1030 and 1130 of FIGS. 10 and 11) as well as a total-power measurement at the OPA architecture. For instance, returning to FIGS. 10 and 11, blocks 1040 and 1140, respectively, may be an optional additional step to blocks 1030 and 1040, respectively.

This dual feedback mechanism may allow for both a preemptive power adjustment, as well as to provide for feedback and prevention of an unstable response by the second SOA 520A, 520B. For instance, a SOA may have a sub-nanosecond response time, which makes SOAs ideal for responding to the fast fluctuations in power induced by atmospheric scintillation. However, due to the extremely fast response time, a closed loop control system may require a feedback controller that has a similar response. Delays in the feedback signal, for example from signal propagation, detection, processing, etc., can affect reliable control and stability of the SOA. If the delay is too large, or unaccounted for, the SOA can become unstable in operation. To address this, control of the optical gain state (or pre-amp) of the second SOA may be driven to adapt to fast changes in the pathloss of the optical link caused by atmospheric scintillation and pointing errors.

As shown in FIG. 9, the total power measurement 910 may be made at the OPA architecture 114. Thus, this total power measurement may be made prior to an incoming optical communications signal reaching the sensor 118 of the first optical communications terminal 102. This total power measurement may be input into the state machine 820 in order to adaptively adjust the gain of the second SOA 520A. In this regard, the second SOA 520A may boost or attenuate an incoming optical communications signal before the incoming optical communications signal reaches the sensor 118 and thereby reduce fluctuations outside of the bounds of operation before such fluctuations are incident on the sensor.

As with the example of FIG. 8, the actual power measurement 810 may be made at the sensor 118. This may be used to provide a feedback trim (e.g., correction) of the driven gain of the second SOA 520A by an additional increase or decrease in the gain in order to maintain the receiver power within a stable band of performance for the first communication device 102. The total power measurement 810 may be similar in nature to the actual power measurement, but the use of the actual power measurement may provide a secondary corrective process to the gain of the second SOA that could not be achieved by using adaptive control based on the total power measurement alone.

As with the example of FIG. 8, the finite state machine 820 may be utilized to set update rate and control loop speed for the second SOA 520A, based on identification of weather patterns for the power measurement 810, 910. In other words this feedback (the power measurements 810, 910) may be fed to the state machine 820 in order to control the second SOA 520A. Again, the control rate may vary from a few Hz's (e.g., 1-2 Hz) to hundreds of Hz's, based on identified atmospheric conditions, and may be adaptively tuned to prevent instability in the feedforward/feedback control of the second SOA.

In some instances, a calibration routine may be run on the first and second SOAs to allow these SOAs to be run in a typical linear range of operation for the first optical communications terminal as well as outside the bound of the typical linear range. This may allow the first optical communications terminal to be run down to transparency and then begin to attenuate an incoming optical communications signal as well. Allowing the second SOA to run both as an optical amplifier (e.g., to increase power), but also as an optical attenuator (e.g., to decrease power), may elimination the need for extra components to provide a saturation clamp on the incoming optical communications signal.

In some instances, the addition of the second SOA in the receive path may unlock the potential for updated receiver architecture. This may include, for example, phase based modulation formats, similar to DPSK, BPSK, QPSK, etc.

In some instances, the total power measurements at the OPA architecture may change over time. For instance, where the OPA architecture includes pairs of balanced photodetectors to modulate incoming optical communications signals, performance should be balanced to one another (e.g., to be within a desired threshold of one another or more or less); however, as the photodetectors age, this performance will degrade. As such, calibration at time of build is not sufficient for characterization of the photodetectors. Moreover, as the number of pairs of photodetectors increases, complexity in the system also increases. In this regard, to adjust for such changes in performance and complexity, the changes in performance of the first optical communications terminal may be measured over time. This may be used, for instance, to update how the state machine for the receive path performs (e.g., by updating thresholds of the state machine).

In some instances, because the gain of the first and second SOAs are actively controlled to maintain margin, the optical communications terminal 102 (or optical communications terminal 122) may be controlled to operate just above threshold. In doing so, the overall total electrical power required for the optical communication terminal to operate over time can be minimized.

The features described herein may provide for an optical communications terminal with co-integration and packaging of an optical transceiver as well as the first and second SOAs which can be used to reduce a cross-coupling effect. Control of the first and second SOAs at different optical communications terminals may be done adaptively without direct feedback or knowledge of the state of the other SOA even while controlling the overall power level of the same communications signal (outgoing at one optical communications terminal and incoming at another optical communications terminal). Thus, the features described herein may also account for the dual independent control of the same optical path (e.g., transmit path of a first optical communications terminal to receive path of a second optical communications terminal).

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising a first optical communications terminal having:
a sensor arranged in a receive path of the first optical communications terminal;
an optical phased array architecture in a receive path of the first optical communications terminal;
a first semiconductor optical amplifier (SOA) arranged in a transmit path of the first optical communications terminal and configured to adjust an outgoing optical communications signal according to power of a first incoming optical communications signal at the sensor; and
a second SOA arranged in the receive path of the first optical communications terminal and configured to adjust a second incoming optical communications signal according to the power of the first incoming optical communications signal at the sensor.

2. The system of claim 1, wherein the second SOA is further configured to adjust the second incoming optical communications signal according to power of the first incoming optical communications signal at the optical phased array architecture.

3. The system of claim 1, further comprising, a state machine configured to control the second SOA based on the power of the first incoming optical communications signal at the sensor.

4. The system of claim 3, wherein the state machine is further configured to control the second SOA based on power of the first incoming optical communications signal at the optical phased array architecture.

5. The system of claim 1, further comprising, a state machine configured to control the first SOA based on the power of the first incoming optical communications signal at the sensor.

6. The system of claim 1, further comprising a second optical communications terminal, wherein the second optical communications terminal is configured to transmit the first incoming optical communications signal and the second incoming optical communications signal.

7. A system comprising a first optical communications terminal having:
a sensor arranged in a receive path of the first optical communications terminal;
an optical phased array architecture in a receive path of the first optical communications terminal;
a first semiconductor optical amplifier (SOA) arranged in a transmit path of the first optical communications terminal and configured to adjust an outgoing optical communications signal according to information included in a first incoming optical communications signal; and
a second SOA arranged in the receive path of the first optical communications terminal and configured to adjust a second incoming optical communications signal according to power of the first incoming optical communications signal at the sensor.

8. The system of claim 7, wherein the second SOA is further configured to adjust the second incoming optical communication signal according to power of the first incoming optical communications signal at the optical phased array architecture.

9. The system of claim 7, further comprising, a state machine configured to control the second SOA based on the power of the first incoming optical communications signal at the sensor.

10. The system of claim 9, wherein the state machine is further configured to control the second SOA based on power of the first incoming optical communications signal at the optical phased array architecture.

11. The system of claim 7, further comprising, a state machine configured to control the first SOA based on the information.

12. The system of claim 7, wherein the information identifies power of a second outgoing optical communications signal received at a sensor of a second optical communications terminal, wherein the second outgoing optical communications signal was transmitted by the first optical communications terminal to the second optical communications terminal.

13. The system of claim 7, further comprising a second optical communications terminal, wherein the second optical communications terminal is configured to transmit the first incoming optical communications signal and the second incoming optical communications signal.

14. A method comprising:
receiving a first incoming optical communications signal at a sensor via a receive path of a first optical communications terminal;
adjusting an outgoing optical communications signal using a first semiconductor optical amplifier (SOA) arranged in a transmit path of the first optical communications terminal, wherein the adjusting is according to power of the first incoming optical communications signal at the sensor; and
adjusting a second incoming optical communications signal using a second SOA arranged in the receive path of the first optical communications terminal, wherein the adjusting is according to power of the first incoming optical communications signal at the sensor.

15. The method of claim 14, further comprising, adjusting the second incoming optical communications signal further according to the power of the first incoming optical communications signal at an optical phased array architecture of the first optical communications terminal.

16. A method comprising:
receiving a first incoming optical communications signal at a sensor via a receive path of a first optical communications terminal;
adjusting an outgoing optical communications signal using a first semi-conductor optical amplifier (SOA) arranged in a transmit path of the first optical communications terminal, wherein the adjusting is according to information included in the first incoming optical communications signal; and
adjusting a second incoming optical communications signal using a second SOA arranged in the receive path of the first optical communications terminal, wherein the adjusting is according to power of the first incoming optical communications signal at the sensor.

17. The method of claim 16, further comprising, adjusting the second incoming optical communications signal further according to the power of the first incoming optical communications signal at an optical phased array architecture of the first optical communications terminal.

18. The method of claim 16, wherein the information identifies power of a second outgoing optical communications signal received at a sensor of a second optical communications terminal, and the method further comprises transmitting the second outgoing optical communications signal by the first optical communications terminal to the second optical communications terminal.
